(19) United States
(12) Patent Application Publication
(10) Pub. No.: US 2018/0110317 A1
(43) Pub. Date: Apr. 26, 2018

(54) Adjustable Fitted Neck And Shoulder Towel

(71) Applicant: Alina Girod, Sun Valley, CA (US)

(72) Inventor: Alina Girod, Sun Valley, CA (US)

(21) Appl. No.: 15/791,928

(22) Filed: Oct. 24, 2017

Related U.S. Application Data
(60) Provisional application No. 62/412,667, filed on Oct. 25, 2016.

(51) Int. Cl. A45D 44/08; A62B 17/00

(52) U.S. Cl. CPC A45D 44/08; A41D 13/0512; A62B 17/006

(57) ABSTRACT

An adjustable fitted neck and shoulder towel (AFNST) that is placed and secured around a person's neck and over the person's shoulders and upper torso. The AFNST is a sheet of single ply or multi ply fabric material with an outer surface, an inner surface, a right edge, a left edge, a lower edge, and an upper edge. Located on the upper edge of the sheet is a semi-circular neck cut-out. Once the AFNST is placed on a person, with the neck cut-out around the person's neck, securing means are utilized to attach two opposing sides of the cut-out. The securing means are preferably a single or dual string, used with or without eyelets. When the two opposing sides of the cut-out are secured together, the AFNST is maintained on the person and provides a barrier layer that protects the person's skin and clothing from spilled or splashed chemicals used during a hair care procedure.

### TECHNICAL FIELD

The invention generally pertains to protective apparel, and more particularly to an adjustable fitted neck/shoulder towel that is wrapped and secured around a person's neck and is draped over a person's shoulders to protect skin and clothes during hair care procedures.

### BACKGROUND ART

Many people, both men and women, utilize hair care professionals for services including hair coloring or hair lightening. Both coloring and lightening typically require the use of chemicals that are applied on the hair. When performing coloring or lightening a hair care professional must be careful and take precautions because the chemicals used can cause damage or injury. Hair color, especially, permanent hair color, can stain/discolor clothes or a person's skin if the color drips or splashes from the hair on which it is applied, or from the applicator used to apply it. For hair lightening, bleach is often used, which in addition to severely damaging clothes can also seriously injure a person if the bleach drips or splashes onto the skin.

As a result of these potential occurrences, hair care professionals place a towel or fabric sheet on the person who is having the coloring or lightening performed. A problem exists in that when using a conventional towel for example, it is difficult to completely wrap or place the towel on the person in a manner that entirely covers and protects the potentially affected areas. This is predominantly a result of the towel's rectangular/square shape. Also, once a towel is placed on a person, it is difficult to maintain the towel in position on the person, especially for extended periods of time and/or if the person tends to move while the procedure is being performed.

What is needed is a towel that is specifically designed to address the needs of a hair care professional, particularly when a procedure such as coloring or lightening is being performed. Optimally, the towel would be designed and shaped to facilitate the complete covering of any/all potentially affected areas including a person's neck and shoulders. The towel could be securely maintained in place on a person, and would be comfortable to wear and unobtrusive. A towel with these features would be significant benefit to both hair care professionals, who must take precautions that their client clothes or skin are not damaged or injured, and for the person on whom the hair care procedure is being performed.

A search of the prior art did not disclose any literature or patents that read directly on the claims of the instant invention. However, the following U.S. patents are considered related.

| PATENT NO. | INVENTOR | ISSUED |
|---|---|---|
| 3,798,674 | Daniel | Mar. 26, 1974 |
| 2003/0088902 | Levy | May 15, 2003 |
| 2015/0342323 | Brown | Dec. 3, 2015 |

The U.S. Pat. No. 3,798,674 patent discloses a drape for protecting the neck and shoulders during hair styling, cutting, shampooing, and the like. The drape includes a generally U-shaped flat bib portion and a U-shaped collar portion which extends upwardly from the bib portion which includes curbed outer and inner peripheries that provides a neck opening. A pair of slits extends inwardly from the outer periphery toward the center of the neck opening, and a collar portion is attached to the periphery of the neck opening. The slits prevent gathering or bunching of the drape, and the collar and bib provide complete protection to the neck and adjacent portions of the chest and back.

The 2003/0088902 publication discloses an improved protective salon garment that may be a cap, smock, a gown, or an apron. The garment includes a protective portion that is constructed of a textile barrier fabric that is substantially impermeable to water, but is also permeable to air and water vapor. The garment includes a protective portion having a neck opening and fastening means for securing the protective portion about the neck and torso of a person.

The 2015/0342323 publication discloses a neck and shoulder protective garment that functions to protect the skin while utilizing a heated grooming device. A neck protection section is attached to a shoulder protection section, and a connection section is attached to the neck protection section and functions to secure the protective garment around the user's neck.

For background purposes, and indicative of the art to which the invention relates, reference may be made to the following remaining patents found in the patent search.

| PATENT NO. | INVENTOR | ISSUED |
|---|---|---|
| 1,995,760 | Webster | Mar. 26, 1935 |
| 2,420,916 | Sorge | May 20, 1947 |
| 2,794,985 | Brennish | Jun. 11, 1957 |
| 4,343,045 | Ferrari | Aug. 10, 1982 |
| 2009/0025127 | McFie, et al | Jan. 29, 2009 |
| 2015/0101098 | McNeill | Apr. 16, 2015 |

### DISCLOSURE OF THE INVENTION

An adjustable fitted neck and shoulder towel (AFNST) that is placed and secured around a person's neck and over the person's shoulders and upper torso. The AFNST is essentially a sheet with an outer surface, an inner surface, a right edge, a left edge, a lower edge, and an upper edge. The AFNST is substantially rectangular shaped and is preferably made of a single ply or multi ply fabric material.

Located on the upper edge of the sheet is a semi-circular neck cut-out. Once the AFNST is placed on a person, with the neck cut-out around the person's neck, securing means are utilized to attach two opposing sides of the neck cut-out. The securing means is preferably comprising of a string, with or without eyelets. Other securing means such as a hook and loop fastener, snap closure, single or multiple button(s) or an insertion clamp can also be used.

When the two opposing sides of the neck cut-out are secured together, the AFNST is maintained on the person and provides a barrier layer that protects the person's skin and clothes during a hair care procedure, such as coloring lighting (bleaching) or relaxing.

To increase the functionally of the AFNST, a waterproof liner can be attached to the inner or outer surface of the sheet, a pad can be placed below the neck cut-out to act as a neck rest, and/or an upward extending collar can be located at the rear of the cut-out to provide additional protection to a person's neck.

In view of the above disclosure, the primary object of the invention is to provide an Adjustable Fitted Neck and Shoulder Towel that is placed on a person during a hair care procedure and protects the person's skin and clothing from chemical spills or splashes that may occur.

In addition to the primary object, it is also an object of the invention to provide an Adjustable Fitted Neck and Shoulder Towel that:
is easy to use,
can be made in various sizes for adults and children,
significantly reduces the danger from chemicals that accidentally spill or splash during a hair care procedure,
can be disposable for one-time use, or washable and re-useable, and
is comfortable when worn,
is cost effective for both a manufacturer and a consumer

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an elevational front view of an adjustable fitted neck/shoulder towel (AFNST) secured around a person's neck and draped over the person's shoulders.

FIG. 2 is a rear elevational view of the AFNST with securing means comprising a fabric strip and dual rings, and having a pad on the inner surface adjacent and below a neck opening.

FIG. 3 is a rear elevational view of the AFNST with securing means comprising opposing sections of a hook and loop fastener, and having a liner on the inner surface.

FIG. 4 is a front elevational view of the AFNST with securing means comprising a single string and an eyelet.

FIG. 5 is a front elevational view of the AFNST with securing means comprising a looped double string extending from each side of the neck opening.

FIG. 6 is a front elevational view of the AFNST with securing means comprising a fabric strip and a single ring.

### BEST MODE FOR CARRYING OUT THE INVENTION

The best mode for carrying out the invention is presented in terms that disclose a preferred embodiment of an adjustable fitted neck/shoulder towel (AFNST).

During many hair care or hair treatment procedures, which include hair cutting, application of color and application of bleach/color lightener, it is necessary to protect the skin and clothes of the person on whom the procedure is being performed. This is for sanitary reasons and because certain procedures require the use of chemicals that could damage/harm the skin and/or clothes of the person.

The AFNST provides a protective cover that is placed and secured around a person's neck and is draped over and across the person's shoulders and upper torso, thereby creating a barrier layer to the person's skin and clothes. The AFNST is an improvement over conventional towels or sheets which are commonly used and are often unsanitary from repeated use or from incidents such as being dropped on the floor. The AFNST also reduces the need and cost of laundering multiple towels or sheets.

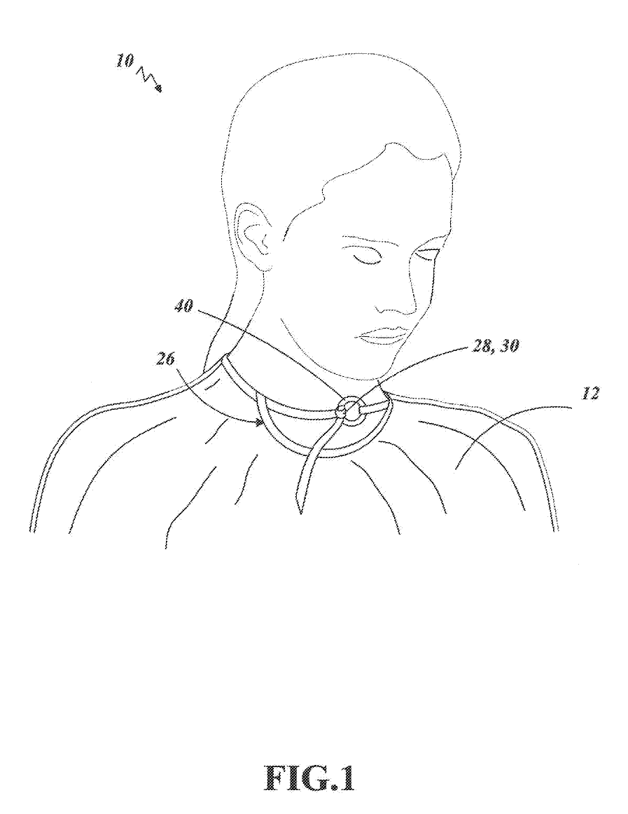

The AFNST 10, as shown in FIGS. 1-6, is comprised of a sheet of preferably fabric material, with an outer surface 12, an inner surface 14, a right edge 16, a left edge 18, a lower edge 20, and an upper edge 22. Located at the substantial midpoint on the upper edge 22 is a neck cut-out 26.

The fabric material of the AFNST 10 can be comprised of a woven cloth, a non-woven cloth, a naturally-derived material such as hemp, a synthetic/man-made material, or a composite material that consists of two or more materials combined into a single material. The AFNST 10 can be single ply or multi ply, with one material used for one ply and a different material used for the other ply. A hair care professional who focuses on the bleaching or lightening of hair might prefer a stronger, multi ply AFNST 10. For the purpose of this disclosure, a single ply material is described and shown. Additionally, other materials such as plastic, nylon or rubber can also be utilized, either in single ply or dual ply configurations. The plastic, nylon, rubber, or other material can also be used in combination with a fabric material. For example, the AFNST can have a fabric outer surface and a plastic inner surface, or the reverse. To increase the functional efficacy of the AFNST 10, a waterproof material can be used, or any material can have a waterproof coating applied.

Also, the AFNST 10 can be made of a disposable (preferably bio-degradable) material, which provides a one-time use AFNST 10. The disposable AFNST 10 can be packaged and sold in an easily accessible container that holds multiple AFNSTS, in a similar manner to a tissue box. There are pros and cons to the non-disposable and disposable AFNST 10 with a major benefit of the non-disposable being that they can be washed and re-used after each use, which is typically less expensive over time, and is more environmentally friendly i.e., green.

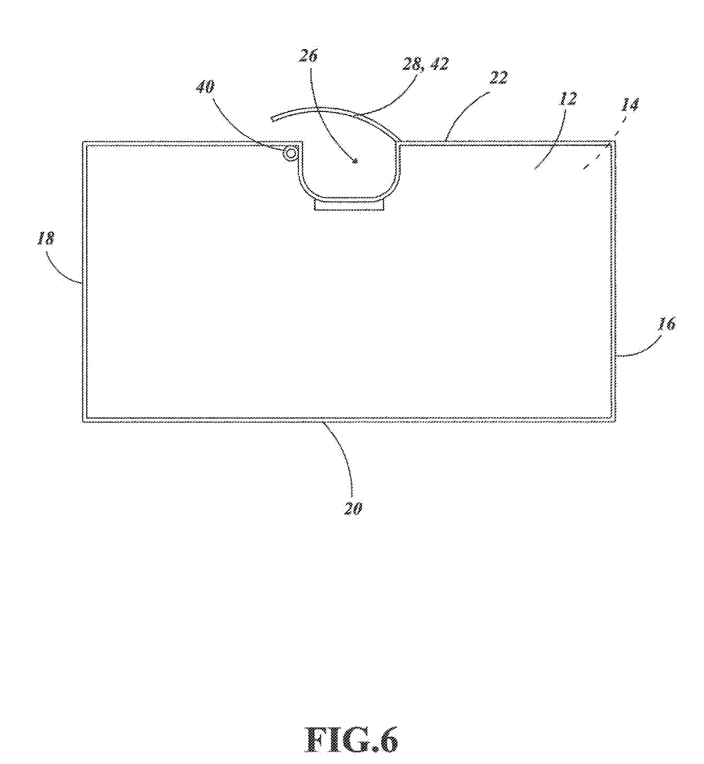

As shown in FIGS. 1-6, the neck cut-out 26 is semi-circular and is dimensioned to fit comfortably around a person's neck. Depending on the use, the neck cut-out 30 can be rear oriented, as shown in FIG. 1, or front oriented, as shown in FIG. 6, and can be larger for large adults, smaller for children and small adults. Additionally, located at the substantial rear half of the neck cut-out 26 is an upward extending collar 58, as shown in FIG. 6, that protects the back side of a person's neck or functions as a neck rest/support for a person who is wearing the AFNST 10. The collar extends upward from 0.50-inch to 1.50-inches and is preferably made of a rigid material, either with or without a fabric covering/layer. The collar can be integral with the AFNST 10, or can be removably attached by means including hook and loop fastener, snap closures, a zipper, or other means. If desired, the collar can also include a liner, preferably made of foam.

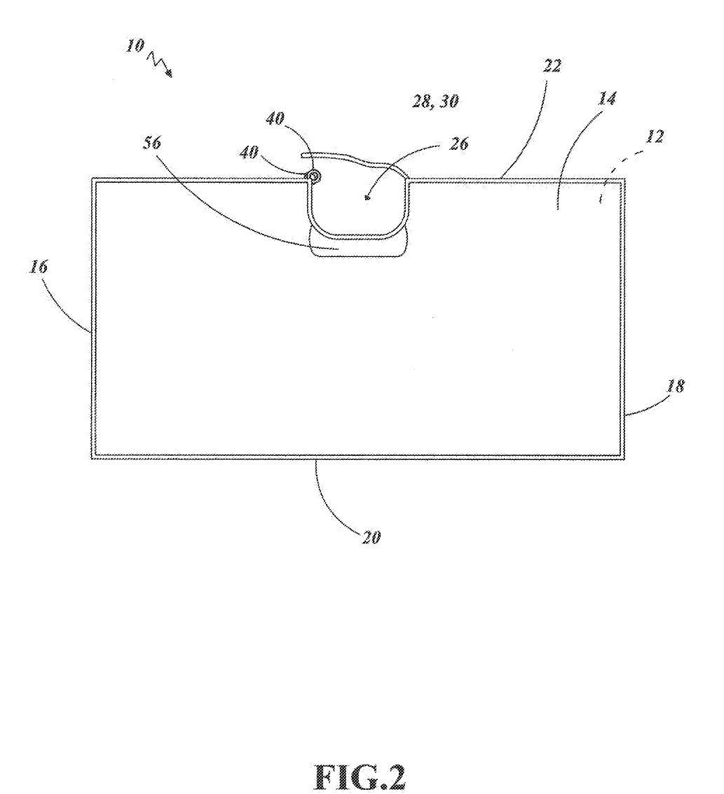

In order to maintain the AFNST 10 on a person, securing means 28 are utilized. The preferred securing means is a single fabric strap 30, as shown in FIG. 2, although there can be many types of securing means 28, and the type used depends on the actual application of the AFNST 10, and the preference of the hair care professional who is performing the specific procedure. Also, it should be noted that the securing means 28 can be located at the front or rear, depending on the orientation of the neck cut-out 26.

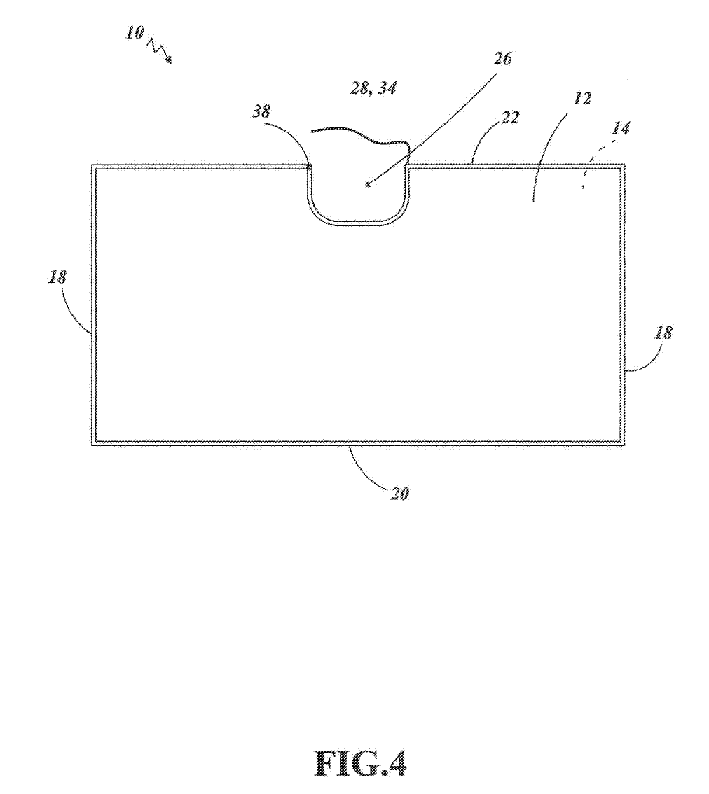

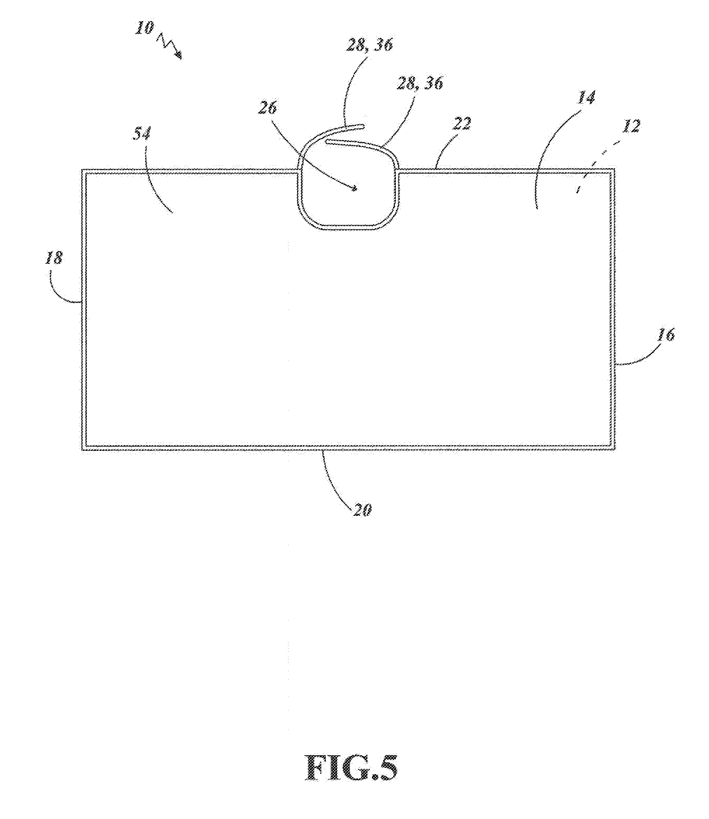

Some examples of securing means 28 include the preferred single strap 30, as shown in FIG. 2, a double strap 32, as shown in FIG. 5, a single string 34, with or without an eyelet 38, as shown in FIG. 4, or a double string 36 with or without an eyelet. To provide a way of connecting and maintaining the strap(s) 30,32, a single ring or dual rings 40, as shown in FIGS. 2 and 6, which preferably made of plastic, can be utilized. The strap(s) 30, 32 is simply inserted through the ring(s) 40 and doubled around, back through the ring 40. Depending on the size of the person's neck, a section of the strap 30 is pulled, which brings the opposing ends of the cut-out 26 together. Once the two ends of the cut-out are as closed together as comfortably possible, the strap is tightened through the ring 40 and secured. At this point, the AFNST is securely and comfortably maintained around a person's neck, with sections of the AFNST 10 draped down over the person's shoulders. Any chemical, such as bleach, that drips or is splashed downward, will land on the AFNST 10, thus protecting the person's skin and their clothes.

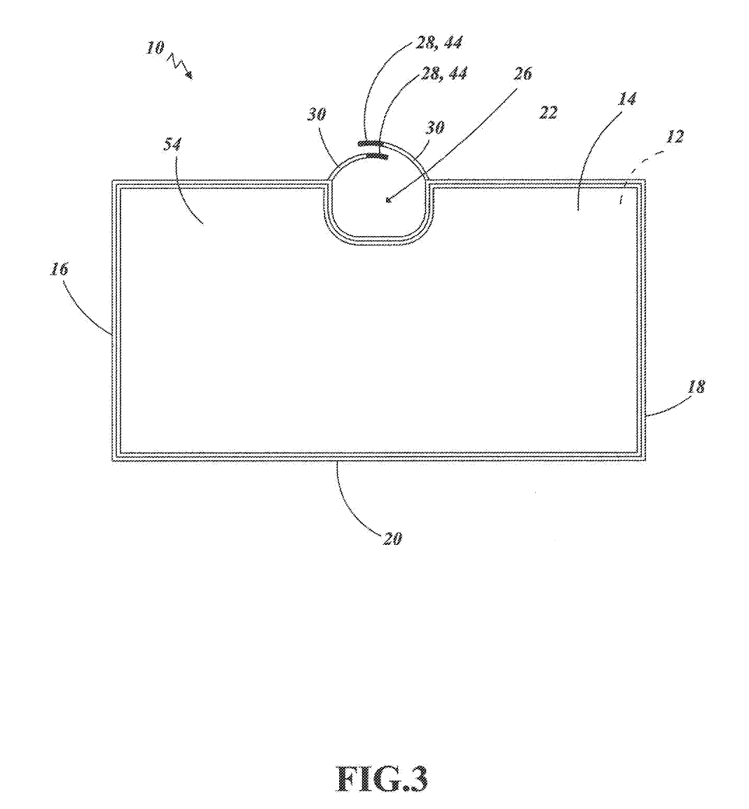

Other examples of securing means 28 include a single or multiple fabric or synthetic straps 30 or strips 42 which can also be used with the ring 40 and function in a similar manner to the string(s); an opposing set of hook and loop fasteners 44; as shown in FIG. 3; a snap closure 46; a single or multiple buttons 48; or an insertion clamp 50 which is commonly seen in use with safety-type belts and consists of male and female ends that are snapped and locked together. All of these securing means, as well as others not disclosed, are effective, and the choice of which to use is left to the preference and decision of the user and/or manufacturer.

To further improve the functionality of the AFNST 10, a liner 54, as shown in FIG. 3, which is preferably made of a synthetic, waterproof material such as plastic or foam, can be attached to the inner surface 14 of the AFNST 10. The liner 54 adds an additional layer of protection against chemical dripping or splashing. And, if desired, a pad 56, as shown in FIG. 2, can be placed adjacent and below the neck cut-out 26. The pad 56 provides a comfortable area on which a person's neck can rest when the AFNST 10 is worn.

In an alternate design the AFNST 10 can be manufactured as a retrofit item for an existing conventional towel. The retrofit AFNST (not shown) would preferably be sold as kit that a person can attach onto a towel. The retrofit design is smaller than the previously disclosed design and functions by being attached by means such as hook and loop fastener, snap closures, buttons, double-sided tape or similar non-permanent means, to a conventional towel. The benefits of the retrofit design are that a person can use his/her existing towels and obtain all of the functionality of the AFNST 10. Once attached, the retrofit design effectively converts a conventional towel into the AFNST 10.

It should be noted that while the AFNST 10 is particularly effective when used during hair coloring or lightening, the AFNST 10 can also be used for any hair care procedure that requires protection or just covering of the clothes or skin or the person on whom the procedure is performed. Additionally, the AFNST 10 is not limited to protection during hair are procedures. The AFNST 10 can be used for any purpose that requires or benefits from as protective cover or barrier that is secured around a person's neck.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. An adjustable fitted neck and shoulder towel (AFNST) that is placed and secured around a person's neck and over the person's shoulders and upper torso, wherein said AFNST is comprised of a sheet having a neck cut-out located on an upper edge of said sheet, wherein once said AFNST is placed on a person, with said neck cut-out around the person's neck, securing means are utilized to attach two opposing sides of said neck cut-out, thereby securing said AFNST on the person and providing a barrier layer that protects the person's skin and clothing during a hair care procedure.

2. The adjustable fitted neck and shoulder towel as specified in claim 1 wherein said AFNST is made of a fabric material.

3. The adjustable fitted neck and shoulder towel as specified in claim 2 wherein the fabric material is selected from the group consisting of a woven cloth, a non-woven cloth, a naturally-derived material, a synthetic material, a composite material, plastic, rubber nylon, or a waterproof material.

4. The adjustable fitted neck and shoulder towel as specified in claim 2 wherein the fabric material is single ply.

5. The adjustable fitted neck and shoulder towel as specified in claim 2 wherein the fabric material is multi ply.

6. The adjustable fitted neck and shoulder towel as specified in claim 5 wherein the multi ply fabric material is comprised of at least two different materials.

7. The adjustable fitted neck and shoulder towel as specified in claim 1 wherein said AFNST is disposable and biodegradable.

8. The adjustable fitted neck and shoulder towel as specified in claim 1 wherein said neck cut-out is semi-circular shaped.

9. The adjustable fitted neck and shoulder towel as specified in claim 1 wherein said securing means for attaching two opposing sides of said neck cut-out are selected from the group consisting of a single strap, a double strap, single string, a double string, hook and loop fasteners, snap closures, a single button, multiple buttons, or a male and female insertion clamp.

10. An adjustable fitted neck and shoulder towel (AFNST) that is placed and secured around a person's neck and over the person's shoulders and upper torso, wherein said AFNST is comprised of a substantially rectangular sheet of fabric material with an outer surface, an inner surface, a right edge, a left edge, a lower edge, and an upper edge, wherein located at a substantial midpoint on the upper edge is a semi-circular neck cut-out wherein once said AFNST is placed on a person, with said neck cut-out around the person's neck, securing means are utilized to pull together and attach two opposing side corners of said neck cut-out, thereby securing said AFNST around the person's neck, with the fabric material below said neck cut-out covering the person's shoulders and upper torso, wherein said AFNST provides a barrier layer that protects the person's skin and clothing during a hair care procedure.

11. The adjustable fitted neck and shoulder towel as specified in claim 10 wherein said sheet of fabric material is selected from the group consisting of a woven cloth, a non-woven cloth, a naturally-derived material, a synthetic material, a composite material, plastic, rubber nylon, or a waterproof material.

12. The adjustable fitted neck and shoulder towel as specified in claim 11 wherein the fabric material is single ply.

13. The adjustable fitted neck and shoulder towel as specified in claim 11 wherein the fabric material is multi ply.

14. The adjustable fitted neck and shoulder towel as specified in claim 13 wherein the multi ply fabric material is comprised of at least two different materials.

15. The adjustable fitted neck and shoulder towel as specified in claim 10 wherein said AFNST is disposable and biodegradable.

16. The adjustable fitted neck and shoulder towel as specified in claim 5 wherein said securing means for pulling together and attaching two opposing side corners of said neck cut-out are selected from the group consisting of a single strap, a double strap, a single string, a double string, hook and loop fasteners, snap closures, a single button, multiple buttons, or a male and female insertion clamp.

17. The adjustable fitted neck and shoulder towel as specified in claim 16 wherein said securing means further comprise at least one eyelet through which said securing means is directed.

18. The adjustable fitted neck and shoulder towel as specified in claim 16 wherein said string securing means further comprise a single ring or double rings located on ends of said securing means, wherein said string securing means is inserted through the ring or rings and double around, each through the ring or rings.

19. The adjustable fitted neck and shoulder towel as specified in claim 10 further comprising a liner that is attached to the inner surface of said fabric sheet, wherein said liner is made of a waterproof material and adds an additional layer of protection against chemical dripping or splashing.

20. The adjustable fitted neck and shoulder towel as specified in claim 10 further comprising a pad that is located adjacent and below said neck cut-out, wherein said pad provides a location where a person can rest his or her neck when said AFNST is secured on the person.

21. The adjustable fitted neck and shoulder towel as specified in claim 10 further comprising an upward extending collar that is located at a rear section adjacent said neck cut-out, wherein said collar provides additional protection to a person's neck when said AFNST is secured on the person.

22. The adjustable fitted neck and shoulder towel as specified in claim 10 wherein said AFNST is manufactured as a retrofit product that is added to an existing conventional towel.
